(19) United States
(12) Patent Application Publication
(10) Pub. No.: US 2026/0306991 A1
(43) Pub. Date: Oct. 8, 2026

(54) SYSTEMS AND METHODS FOR OPTIMIZING CARBON DIOXIDE CAPTURE USING WATER VAPOR ADSORPTION

(71) Applicant: GE Vernova Infrastructure Technology LLC, Greenville, SC (US)

(72) Inventors: Szymon Pawel MODELSKI, Schenectady, NY (US); Douglas BEADIE, Schenectady, NY (US); Anindya Kanti DE, Schenectady, NY (US); Raub Warfield SMITH, Schenectady, NY (US)

(21) Appl. No.: 19/481,019

(22) PCT Filed: Aug. 16, 2023
(86) PCT No.: PCT/US2023/030313

§ 371 Date: Nov. 3, 2025

Related U.S. Application Data
(63) Continuation of application No. PCT/US2023/021536, filed on May 9, 2023.
Application No. PCT/US2023/021536 is a continuation of application No. PCT/US2023/021542, filed on May 9, 2023.
Application No. PCT/US2023/021542 is a continuation of application No. PCT/US2023/026240, filed on Jun. 26, 2023.
Application No. PCT/US2023/026240 is a continuation of application No. PCT/US2023/028573, filed on Jul. 25, 2023.

(51) Int. Cl. B01D 53/04; B01D 53/26

(52) U.S. Cl. CPC B01D 53/0438; B01D 53/0454; B01D 53/261; B01D 2257/504; B01D 2257/80; B01D 2259/40088; B01D 2259/404

(57) ABSTRACT

A method for capturing carbon dioxide. The method includes receiving, by one or more adsorbent beds comprising one or more adsorption modules, a gas stream, wherein each of the one or more adsorption modules comprise one or more solid sorbent materials. The method also includes receiving, by a contactor, a regulating fluid stream for use in controlling a temperature of the one or more adsorption modules. The method also includes adsorbing, by a first adsorption module of the one or more adsorption modules, water vapor from the gas stream, and adsorbing, by one or more subsequent adsorption modules of the one or more adsorption modules, carbon dioxide from the gas stream. The method further includes discharging, by the one or more adsorbent beds, an exhaust stream, and modulating the temperature of the first adsorption module based on a solid sorbent material within the first adsorption module.

### BACKGROUND OF THE INVENTION

The present disclosure relates generally to capture systems and methods and, more specifically, to systems and methods that facilitate optimizing the adsorption and desorption of water vapor by a first adsorption module of an adsorbent bed to optimize the adsorption and desorption of carbon dioxide gas by subsequent adsorption modules of the adsorbent bed.

At least some known industrial and power generation processes may result in the production of a gas stream containing contaminants, such as carbon dioxide (CO₂). To facilitate removing the contaminants from the gas stream prior to an exhaust stream being released into the atmosphere, at least some known systems include a capture system. For example, capture systems may be used to capture CO₂ and store the CO₂ underground to facilitate reducing an amount of CO₂ undesirably released into the atmosphere.

At least some known capture systems use an adsorbent bed to capture CO₂. In some of such capture systems, a sorbent material may be used with the adsorbent bed to enhance the adsorption and desorption of CO₂. To facilitate increasing the amount of CO₂ captured, at least some known capture systems use direct heating and cooling of the adsorbent bed. However, direct heating and cooling may contaminate the sorbent material.

In some known systems, solid sorbent materials may be used with adsorbent beds to enhance the adsorption and desorption of CO₂, as opposed to conventional liquid-amine based CO₂ capture processes, improving adsorption capacity and efficiency. However, the effectiveness of solid sorbent systems may be limited based on the chemical structure and/or the thickness of the solid sorbent materials. Additionally, the presence of water (H₂O) in the gas stream, such as in the form of water vapor, may decrease the effectiveness of the adsorption and desorption by the solid sorbent material.

Accordingly, there exists a need for capture systems and methods that use temperature management and physical and chemical characteristics of one or more solid sorbents to optimize the efficiency and productivity of water vapor adsorption and desorption by a first adsorption module of an adsorbent bed, thereby optimizing the adsorption and desorption of carbon dioxide gas by subsequent adsorption modules of the adsorbent bed.

### BRIEF DESCRIPTION OF THE INVENTION

In one aspect, a method for capturing carbon dioxide is provided. The method includes receiving, by one or more adsorbent beds including one or more adsorption modules, a gas stream, wherein each of the one or more adsorption modules include one or more solid sorbent materials having one or more sorbent properties. The method also includes receiving, by a contactor, a regulating fluid stream for use in controlling a temperature of the one or more adsorption modules, wherein the regulating fluid stream comprises a cold stream and a hot stream. The method also includes adsorbing, by a first adsorption module of the one or more adsorption modules via a solid sorbent material of the one or more solid sorbent materials, water vapor from the gas stream, and adsorbing, by one or more subsequent adsorption modules of the one or more adsorption modules via the one or more solid sorbent materials, carbon dioxide from the gas stream. The method further includes discharging, by the one or more adsorbent beds, an exhaust stream, and modulating the temperature of the first adsorption module based on the one or more sorbent properties of the solid sorbent material within the first adsorption module to facilitate regulating an amount of water vapor captured and subsequently released by the first adsorption module.

In another aspect, a capture system for use in capturing carbon dioxide is provided. The capture system includes one or more adsorbent beds including one or more adsorption modules, wherein the one or more adsorption modules include one or more solid sorbent materials having one or more sorbent properties. The one or more adsorbent beds are oriented to receive a gas stream, adsorb water vapor from the gas stream within a first adsorption module of the one or more adsorption modules via a solid sorbent material of the one or more solid sorbent materials, adsorb carbon dioxide from the gas stream within one or more subsequent adsorption modules of the one or more adsorption modules via the one or more solid sorbent materials, and discharge an exhaust stream depleted of water vapor and carbon dioxide. The capture system also includes a contactor oriented to receive a regulating fluid stream for use in controlling a temperature of the one or more adsorption modules and a controller configured to modulate the temperature of the first adsorption module based on the one or more sorbent properties of the solid sorbent material within the first adsorption module to facilitate regulating an amount of water vapor captured and subsequently released by the first adsorption module.

### BRIEF DESCRIPTION OF THE DRAWINGS

FIG. 1 is a schematic illustration of an exemplary capture system that may be used to capture CO₂.

FIG. 2 is a perspective schematic illustration of an exemplary adsorption module that may be used with the capture system of FIG. 1.

FIG. 3 is a schematic illustration of an alternative exemplary capture system that may be used to capture CO₂.

FIG. 4 is a schematic of an exemplary control system that may be used with the capture systems of FIG. 1 and FIG. 3.

FIG. 5 is a schematic illustration of an alternative capture system that may be used to capture CO₂.

FIG. 6 is a flowchart illustrating an exemplary method for capturing CO₂.

### DETAILED DESCRIPTION OF THE INVENTION

The embodiments described herein relate to systems and methods that use temperature management and physical and chemical characteristics of one or more solid sorbents to optimize the efficiency and productivity of water vapor adsorption and desorption by a first adsorption module of an adsorbent bed, thereby optimizing the adsorption and desorption of carbon dioxide gas by subsequent adsorption modules of the adsorbent bed. The advantages of the systems and methods described herein, over the prior art, include, at least: (i) increasing the efficiency and performance of carbon dioxide adsorption and desorption within subsequent adsorption modules of the adsorbent bed by adsorbing and desorbing water vapor from the gas stream in the first adsorption module of the adsorbent bed; (ii) increasing the efficiency and performance of water vapor adsorption and desorption by varying chemical characteristics of one or more sorbents within a first adsorption module of an adsorbent bed, including, but not limited to, the chemical structure; and (iii) increasing the efficiency and performance of water vapor adsorption and desorption by varying physical characteristics of one or more sorbents within the first adsorption module of the adsorbent bed, including, but not limited to, the sorbent thickness.

When introducing elements of various embodiments disclosed herein, the articles “a,” “an,” “the,” and “said” are intended to mean that there are one or more of the elements. The terms “comprising,” “including,” and “having” are intended to be inclusive and mean that there may be additional elements other than the listed elements.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

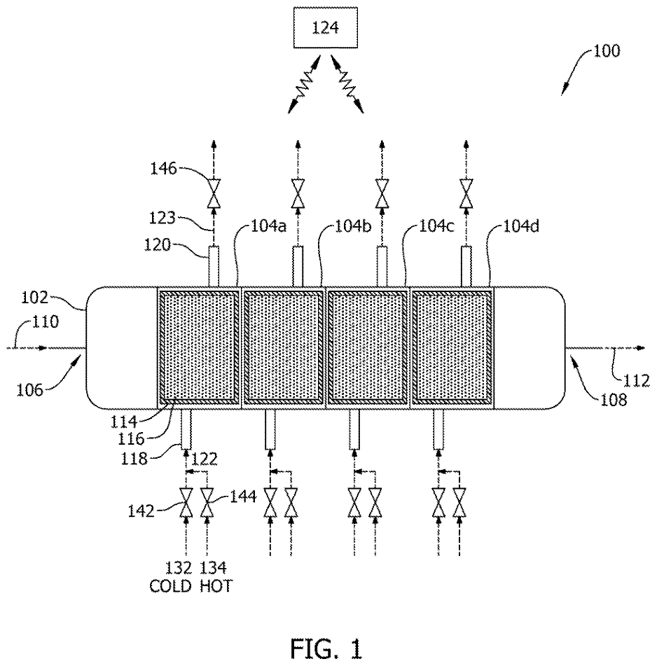

FIG. 1 is a schematic illustration of an exemplary capture system 100 that may be used to capture CO₂ using an adsorbent bed 102. In the exemplary embodiment, the adsorbent bed 102 includes at least one adsorption module 104. More specifically, in the exemplary embodiment, adsorbent bed 102 includes four adsorption modules 104a-d. In some embodiments, capture system 100 may include more or less than four adsorption modules 104. Moreover, in the exemplary embodiment, the adsorbent bed 102 includes an inlet 106 and an outlet 108. The inlet 106 and the outlet 108 are oriented such that during operation, a gas stream 110 received through the inlet 106 is channeled through each adsorption module 104 in series towards the outlet 108. As the gas stream 110 is channeled through each adsorption module 104, the adsorbent bed 102 captures H₂O and CO₂ from the gas stream 110 and discharges an exhaust stream 112 through the outlet 108 that is depleted of CO₂.

Generally, the gas stream 110 may be any suitable gas known in the art that includes contaminants targeted for removal. For example, the gas stream 110 may be air, flue gas, post-combustion gas, natural gas, and/or combinations thereof. In the exemplary embodiment, the gas stream 110 includes CO₂. In some embodiments, CO₂ may be present in the gas stream 110 in a range of from about 400 ppm to about 15v %. In other embodiments, CO₂ may be present in the gas stream 110 in a range of from about 0.04v % to about 30v %.

In the exemplary embodiment, the concentration of CO₂ of the gas stream 110 is generally at its highest as the gas stream 110 enters the inlet 106. As CO₂ is adsorbed by each subsequent adsorption module 104, the concentration of CO₂ in the gas stream 110 is reduced as the gas stream 110 is channeled through the adsorption modules 104a-d towards the outlet 108. In the exemplary embodiment, the concentration of CO₂ in the gas stream 110 flowing through the adsorption modules 104a-d is at its lowest at the outlet 108.

Additionally, in the exemplary embodiment, the gas stream 110 includes H₂O. For example, the gas stream 110 may be received by the first adsorption module 104a of adsorbent bed 102 at a specific humidity. In the exemplary embodiment, the concentration of H₂O is generally at its highest as the gas stream 110 enters the inlet 106.

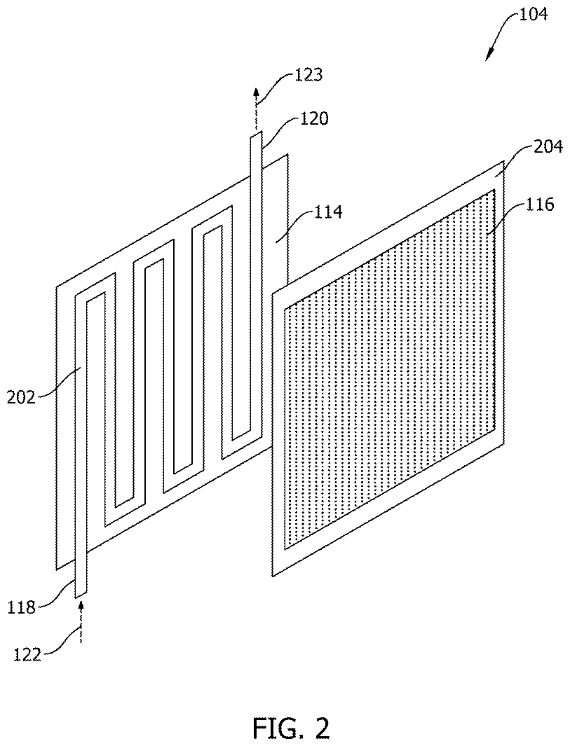

In the exemplary embodiment, the adsorption module 104 includes a contactor 114. The contactor 114 includes a contactor inlet 118, a contactor outlet 120, and a fluid circuit 202 (shown in FIG. 2) defined between and extending from the contactor inlet 118 to the contactor outlet 120. In the exemplary embodiment, the adsorption module 104 also includes a plate 204 (shown in FIG. 2) on which a sorbent 116 is coated, in a solid form, to facilitate adsorbing CO₂ or H₂O. For example, the sorbent 116 may be, but is not limited to only being, in the form of powder, composites mixed with binders, films or coating, packed beds, and/or columns. In some embodiments, the sorbent 116 may be the same within each adsorption module 104 if all adsorption modules 104a-d are configured to capture CO₂. In other embodiments, the sorbent 116 may be different within at least one adsorption module 104 if at least one of the adsorption modules 104a-d is configured to capture H₂O. In the exemplary embodiment, the contactor 114 and the plate 204 are adjacent to each other to facilitate indirect heating and/or cooling of the sorbent 116 coated on the plate 204.

In the exemplary embodiment, a stream 122 received through the contactor inlet 118 facilitates modulating the temperature of the sorbent 116 coated on the plate 204 via heat transfer between the stream 122 flowing within the fluid circuit 202 (shown in FIG. 2) and the plate 204. For example, a regulated temperature Treg of the stream 122 may be used to increase or decrease a control temperature T_{cntl} of the adsorption module 104. In some embodiments, the stream 122 may be in a liquid form. In other embodiments, the stream 122 may be in a gaseous form. Convection between the stream 122 flowing through the fluid circuit 202 and the sorbent 116 coated on the plate 204 facilitates controlling a temperature of the sorbent 116 without the risk of contamination that could occur from direct contact with the stream 122. The design of contactor 114 as shown in FIG. 2 is meant as illustrative and is not intended to limit the design of the contactor 114. For example, in some embodiments, the design of the contactor 114 may differ from that shown in FIG. 2 for one or more adsorption modules 104.

In the exemplary embodiment, the stream 122 is composed of a mixture of a cold stream 132 and a hot stream 134 and exits the contactor outlet 120 as a mixed stream 123. The mixture of the cold stream 132 and the hot stream 134 facilitates modulating the temperature of the sorbent 116. For example, a mixture of the cold temperature T_{cld} of the cold stream 132 and a hot temperature Tₕₒₜ of the hot stream 134 may be used to increase or decrease the regulated temperature T_{reg} of the stream 122 in order to control the control temperature T_{cntl} of the adsorption module 104. In some embodiments, the cold and hot streams 132, 134 each include water, H₂O, in either a liquid (e.g., water) or a gaseous (e.g., steam) form. For example, H₂O may be present in the cold stream 132 and/or the hot stream 134 in a range of from about 50 v % to 100 v %. In other embodiments, the cold stream 132 and/or the hot stream 134 may include a non-water fluid.

In the exemplary embodiment, the capture system 100 also includes a controller 124 that dynamically adjusts operation of the capture system 100. For example, the controller 124 may facilitate optimizing the capture of CO₂ by changing the regulated temperature T_{reg} of the stream 122 to control the control temperature T_{cntl} of at least one adsorption module 104, with the change in temperature being based on physical and/or chemical characteristics of the sorbent 116, as described further herein.

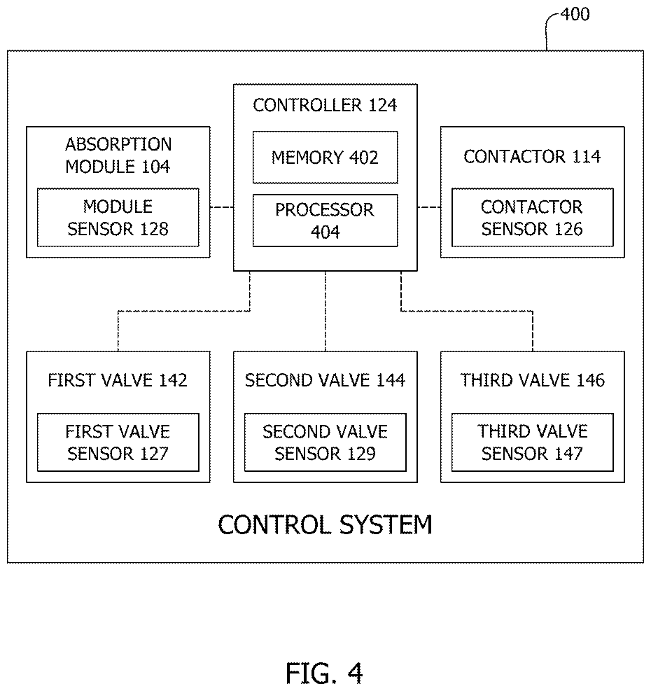

The controller 124 facilitates modulating the temperature of each adsorption module 104a-d by monitoring the temperature of the stream 122 and/or the temperature of the sorbent 116 across the plate 204 (shown in FIG. 2). For example, the controller 124 may monitor the regulated temperature T_{reg} of the stream 122 using a contactor sensor 126 (shown in FIG. 4). Additionally, for example, the controller 124 may monitor the control temperature T_{cntl} of at least one adsorption module 104 using a module sensor 128 (shown in FIG. 4).

In operating conditions where the control temperature T_{cntl} of at least one adsorption module 104 is lower than desired, the controller 124 may selectively increase the regulated temperature T_{reg} of the stream 122, thereby indirectly increasing the temperature of the at least one adsorption module 104. Alternatively, in operating conditions where the control temperature T_{cntl} of at least one adsorption module 104 is higher than desired, the controller 124 may selectively decrease the regulated temperature T_{reg} of the stream 122, thereby indirectly reducing the temperature of the at least one adsorption module 104.

The controller 124 may also monitor the regulated temperature T_{reg} of the stream 122 using a first valve sensor 127 (shown in FIG. 4) and a second valve sensor 129 (shown in FIG. 4). For example, the first valve sensor 127 (shown in FIG. 4) may monitor the cold temperature T_{cld} of the cold stream 132 as the cold stream 132 flows through a first valve 142. Additionally, for example, the second valve sensor 129 (shown in FIG. 4) may monitor the hot temperature Tₕₒₜ of the hot stream 134 as the hot stream 134 flows through a second valve 144.

In operating conditions where the control temperature T_{cntl} of at least one adsorption module 104 is lower than desired, the controller 124 may selectively increase the flow of the hot stream 134 through the second valve 144 and/or selectively decrease the flow of the cold stream 132 through the first valve 142, based on the hot temperature Tₕₒₜ of the hot stream 134 and/or the cold temperature T_{cld} of the cold stream 132 as sensed by the first valve sensor 127 and/or the second valve sensor 129. Alternatively, in operating conditions where the control temperature T_{cntl} of at least one adsorption module 104 is higher than desired, the controller 124 may selectively decrease the flow of the hot stream 134 through the second valve 144 and/or selectively increase the flow of the cold stream 132 through the first valve 142, based on the hot temperature Tₕₒₜ of the hot stream 134 and/or the cold temperature T_{cld} of the cold stream 132 as sensed by the first valve sensor 127 and/or the second valve sensor 129. In the exemplary embodiment, the controller 124 facilitates modulating the temperature of each adsorption module 104a-d by concurrently monitoring the flow and temperature of the stream 122. The controller 124 may facilitate modulating the temperature of each adsorption module 104a-d depending on whether the adsorption module 104 is adsorbing or desorbing H₂O or CO₂.

Generally, the regulated temperature T_{reg} of the stream 122, and thereby the temperature of the adsorption module 104, may be any suitable temperature known in the art that facilitates the capture of H₂O or CO₂ by the systems described herein. In the exemplary embodiment, the regulated temperature T_{reg} of the stream 122 is monitored within each adsorption module 104a-d. In some embodiments, the regulated temperature T_{reg} of the stream 122 may be substantially uniform across each adsorption module 104. In other embodiments, the regulated temperature T_{reg} of the stream 122 may vary across different adsorption modules 104a-d.

Generally, the flow of the stream 122 and the mixed stream 123 may be any suitable flow known in the art that facilitates the capture of H₂O or CO₂ by the systems described herein. In the exemplary embodiment, the flow of the stream 122 is monitored within each adsorption module 104a-d and the flow of the mixed stream 123 is monitored exiting each adsorption module 104a-d. In some embodiments, the flow of the stream 122 and/or the mixed stream 123 may be substantially uniform across each adsorption module 104a-d. In other embodiments, the flow of the stream 122 and/or the mixed stream 123 may vary across different adsorption modules 104a-d.

Additionally, the controller 124 may vary the regulated temperature T_{reg} of the stream 122 within any of the adsorption modules 104a-d. For example, one or more adsorption modules 104a-d may include one or more module sensors 128 (shown in FIG. 4). Thus, the controller 124 may create a temperature profile that includes varied values of the regulated temperature T_{reg} of the stream 122 within any or all of the adsorption modules 104a-d.

The regulated temperature T_{reg} of the stream 122 may be based on the temperature of an extraction flow (not shown) from a steam turbine (not shown). For example, the steam turbine may be part of a combined cycle power plant (not shown), with the extraction flow from the steam turbine being used to change the temperature of the stream 122. In some embodiments, the extraction flow may heat the stream 122 through convective transfer via one or more heat exchangers (not shown) either directly in lieu of mixing the cold and hot streams 132, 134 or indirectly to heat the hot stream 134.

Furthermore, the controller 124 may facilitate modulating the temperature of each adsorption module 104a-d by monitoring the flow of the mixed stream 123 through a third valve 146. For example, the controller may monitor the flow of the mixed stream 123 exiting the adsorption module 104 using a third valve sensor 147 (shown in FIG. 4). In operating conditions where the control temperature T_{cntl} of at least one adsorption module 104 is lower and/or higher than desired, the controller 124 may selectively change the flow of the mixed stream 123 through the third valve 146 depending on whether the adsorption module 104 is adsorbing or desorbing H₂O or CO₂.

Generally, the hot temperature Tₕₒₜ of the hot stream 134 and the cold temperature T_{cld} of the cold stream 132, and thus the regulated temperature T_{reg} of the stream 122 and the control temperature T_{cntl} of the adsorption module 104, may be any suitable temperature known in the art that facilitates the capture and release of H₂O or CO₂ by the systems described herein. In the exemplary embodiment, the regulated temperature T_{reg} of the stream 122 is monitored within each adsorption module 104a-d. In some embodiments, the regulated temperature T_{reg} of the stream 122 may be substantially uniform across each adsorption module 104a-d. In other embodiments, the regulated temperature T_{reg} of the stream 122 may vary across different adsorption modules 104a-d.

In the exemplary embodiment, the first adsorption module 104a is used to adsorb and desorb H₂O included in the gas stream 110. Optimizing the operating conditions of the first adsorption module 104a for adsorption and desorption of H₂O facilitates optimizing the operating conditions of the subsequent adsorption modules (e.g., the second, third, and fourth adsorption modules 104b, 104c, 104d) for adsorption and desorption of CO₂. In some embodiments, the first adsorption module 104a may include one solid sorbent material (e.g., one of sorbent 116) to adsorb and desorb H₂O. In other embodiments, the first adsorption module 104a may include one or more solid sorbent materials (e.g., one or more of sorbent 116) to adsorb and desorb H₂O, which may be the same or different solid sorbent material.

For example, the adsorption and desorption of H₂O by the first adsorption module 104a may be optimized using changes in physical and/or chemical characteristics of the sorbent 116 within the first adsorption module 104a. In the exemplary embodiment, the controller 124 facilitates modulating the temperature of the first adsorption module 104a based on physical and/or chemical characteristics of the sorbent 116. For example, the adsorption and/or desorption capacity of the adsorbent bed 102 may be controlled by varying the control temperature T_{cntl} of the first adsorption module 104a based on a chemical structure of the sorbent 116 within the first adsorption module 104a. Generally, tailoring the chemical structure of the sorbent 116 within the first adsorption module 104a based on the concentration of H₂O in the gas stream 110 channeled through the first adsorption module 104a increases the efficiency of the adsorbent bed 102.

The sorbent 116 within the first adsorption module 104a may be any suitable sorbent known in the art that facilitates the capture of H₂O as described herein. Properties of the sorbent 116 such as porosity, stability, particle morphology, and conductivity may be tailored for specific applications. As such, tailoring the chemical structure of the sorbent 116 may include, but is not limited to, its porosity, stability, particle morphology, and/or conductivity. Additionally, a thickness of the sorbent 116 within the first adsorption module 104a may be of any suitable thickness known in the art that facilitates the capture of H₂O.

In some embodiments, the desorption within the adsorption bed 102 may occur concurrently for both CO₂ and H₂O. As such, in these embodiments, the desorbed CO₂ and H₂O will need to be separated downstream. In other embodiments, the desorption within the adsorption bed 102 may occur in sequence for CO₂ and H₂O. For example, the first adsorption module 104a, or subsequent adsorption modules 104a-d, may be controlled to desorb one of CO₂ or H₂O first, and then the other of CO₂ or H₂O second, such as by sequencing the heating up of the one or more solid sorbent material specific to the desorption of CO₂ or H₂O.

Generally, the temperature of the gas stream 110 entering the fourth adsorption module 104d is higher than the temperature of the gas stream 110 entering any of the first through third adsorption modules 104a-c due to the heat generated by the exothermic process of adsorbing H₂O in the first adsorption module and adsorbing CO₂ in the second and third adsorption modules 104b, 104c. Thus, the temperature of the gas stream 110 generally increases as the gas stream 110 is channeled from the first adsorption module 104a to the fourth adsorption module 104d. Accordingly, in the exemplary embodiment, the temperature of the stream 122 varies across different adsorption modules 104a-d based on the control temperature T_{cntl} of, and heat generation within, each adsorption module 104a-d as well as the molecule being adsorbed. For example, the temperature of the stream 122 may be lowest for the fourth adsorption module 104d to maximize CO₂ capture from the gas stream 110 at its lowest CO₂ content across the adsorption modules 104a-d. Additionally, for example, the temperature of the stream 122 may be highest for the second adsorption module 104b to manage CO₂ capture during the adsorption mode of operation for which the gas stream 110 is at its highest CO₂ content across the adsorption modules 104a-d after the H₂O in the gas stream 110 has been adsorbed by the first adsorption module 104a, which will have its own optimum control temperature.

By varying the regulated temperature Treg of the stream 122 and/or the temperature of the mixed stream 123 across different adsorption modules 104a-d, the controller 124 may facilitate optimizing the adsorption of H₂O and CO₂ of the adsorbent bed 102 to increase the adsorption and desorption capacity of the adsorbent bed 102. Generally, increasing a percentage of module capacity used by at least one adsorption module 104a-d increases the efficiency of the capture system 100. For example, varying the regulated temperature Treg of the stream 122 and/or the temperature of the mixed stream 123 across adsorption modules 104a-d to decrease the control temperature T_{cntl} of subsequent adsorption modules 104a-d may increase the percentage of module capacity used by the subsequent adsorption modules (such as adsorption modules 104b-d), thereby increasing the efficiency of the capture system 100.

Additionally, by varying the regulated temperature T_{reg} of the stream 122 based on physical characteristics of the sorbent 116 within the first adsorption module 104a, the controller 124 may facilitate optimizing the adsorption of CO₂ of the adsorbent bed 102 by regulating a H₂O and increasing a CO₂ adsorption and desorption capacity of the adsorbent bed 102. For example, varying the regulated temperature Treg of the stream 122 within the first adsorption modules 104a to optimize the adsorption and desorption of H₂O based on the thickness of the sorbent 116 may increase the percentage of module capacity used by one or more subsequent adsorption modules 104b-d for the adsorption and desorption of CO₂, thereby increasing the efficiency of the capture system 100.

Furthermore, by varying the regulated temperature Treg of the stream 122 based on chemical characteristics of the sorbent 116 within the first adsorption module 104a, the controller 124 may facilitate optimizing the adsorption and desorption of H₂O and CO₂ of the adsorbent bed 102 by increasing an adsorption and desorption capacity of the adsorbent bed 102. For example, varying the regulated temperature Treg of the stream 122 within the first adsorption module 104a to optimize the adsorption and desorption of H₂O based on the chemical structure of the sorbent 116 may increase the percentage of module capacity used by one or more subsequent adsorption modules 104b-d for the adsorption and desorption of CO₂, thereby increasing the efficiency of the capture system 100. The regulated temperature Treg of the stream 122 may be based on changes to chemical structure properties such as, but not limited to, porosity, stability, particle morphology, conductivity, compounds and/or linkers, geometry, size, shape, and/or internal surface property.

FIG. 2 is a schematic illustration of the adsorption module 104 including the contactor 114 and the plate 204. In the exemplary embodiment, the contactor 114 includes the fluid circuit 202 extending between the contactor inlet 118 and the contactor outlet 120. The plate 204 is coated with the sorbent 116 to adsorb CO₂ or H₂O. In the exemplary embodiment, the contactor 114 and the plate 204 are in close proximity to each other to facilitate indirect heating and/or cooling of the sorbent coated on the plate 204.

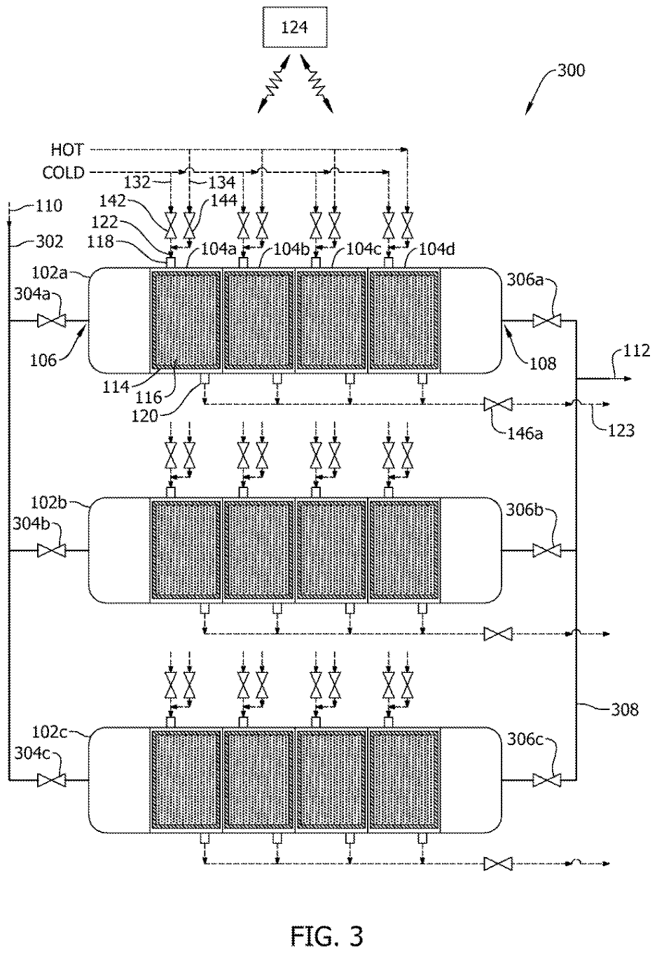

FIG. 3 is a schematic illustration of an exemplary capture system 300 that may be used to capture CO₂ using a plurality of adsorbent beds 102. In the exemplary embodiment, system 300 includes three adsorbent beds 102a-c. The capture system 300 illustrated in FIG. 3 is similar to the capture system 100 (shown in FIG. 1), with the differences noted below, and as such, the same reference numbers for the same components are used in FIG. 3 as were used in FIG. 1. In the exemplary embodiment, the inlet 106 of each adsorbent bed 102 is connected in parallel by an inlet line 302. In some embodiments, capture system 300 may include more or less than three adsorbent beds 102a-c.

In the exemplary embodiment, the gas stream 110 is channeled through the inlet line 302, wherein the flow of the gas stream 110 through each respective adsorbent bed 102 is controlled via a plurality of respective inlet valves 304. In the exemplary embodiment, each inlet valve 304 is in communication with the controller 124 to enable the controller 124 to selectively control the flow of the gas stream 110 from the inlet line 302 through the corresponding adsorbent bed 102. For example, in the exemplary embodiment, inlet valve 304a controls a flow of gas stream 110 to adsorbent bed 102a. In the exemplary embodiment, the outlet 108 of each adsorbent bed 102a-c is coupled in parallel by an outlet line 308 such that the exhaust stream 112 is channeled from each adsorbent bed 102 through the outlet line 308 to be discharged from the capture system 300. Additionally, the mixed stream 123 outputted from one or more adsorbent beds 102a-c may be processed or routed for reuse as the hot stream 134 and/or the cold stream 132 in one or more other adsorbent beds 102a-c via heat addition or rejection exchangers (not shown in Figures).

In the exemplary embodiment, the controller 124 may control the flow of the gas stream 110 into the adsorbent beds 102a-c through control of the inlet valves 304a-c. The selective use of at least one adsorbent bed 102a-c to capture H₂O and CO₂ from the gas stream 110 may facilitate optimizing the efficiency of the capture system 300. For example, the controller 124 may use a minimum number of adsorbent beds 102a-c as needed to facilitate optimizing the capture of H₂O and/or CO₂ from the gas stream 110. Accordingly, flow of the gas stream 110 into at least one adsorbent bed 102a-c may be adjusted by the controller 124 by selectively opening and/or closing at least one of the inlet valves 304a-c. When an adsorbent bed 102 is not receiving the gas stream 110, an exhaust isolation valve 306 may be closed. Additionally, for example, the controller 124 may use more than one of adsorbent beds 102a-c in parallel to optimize the capture of H₂O and/or CO₂ from the gas stream 110. Accordingly, the flow of the gas stream 110 into and out of at least one adsorbent bed 102a-c may be variably adjusted by the controller 124 by selectively opening and/or closing at least one of the inlet valves 304a-c. In the exemplary embodiment, the contactor outlet 120 of each adsorption module 104 is connected in parallel to an outlet line 308.

FIG. 4 is a schematic of an exemplary control system 400 that may be used to capture H₂O and CO₂ with a capture system, such as the capture system 100 (shown in FIG. 1) and/or the capture system 300 (shown in FIG. 3). In the exemplary embodiment, the controller 124 includes a memory 402 and a processor 404. The controller 124 may adjust the temperature of one or more adsorption modules 104a-d based on data received by the control system 400 from the contactor sensor 126, such as, but not limited to, the regulated temperature Treg of the stream 122 and/or the mixed stream 123 (shown in FIG. 1). The controller 124 may adjust the temperature of one or more adsorption modules 104a-d based on comparisons to data stored in the memory 402, such as desired ranges of the regulated temperature T_{reg}, instructions stored in the memory 402, and/or data analyzed by the processor 404.

Additionally, the controller 124 may adjust the temperature of one or more adsorption modules 104a-d based on data received by the control system 400 from the module sensor 128, such as, but not limited to, the control temperature T_{cntl} of one or more adsorption modules 104. The controller 124 may adjust the temperature of one or more adsorption modules 104 based on comparisons to data stored in the memory 402, such as desired ranges of the control temperature T_{cntl}, instructions stored in the memory 402, and/or data analyzed by the processor 404.

The controller 124 may also adjust the temperature of at least one adsorption module 104a-d based on data received by the control system 400 from the first valve sensor 127, the second valve sensor 129, and/or the third valve sensor 147, such as, but not limited to, the temperature and/or the flow of the stream 122 and/or the mixed stream 123. The controller 124 may adjust the temperature and/or the flow of the stream 122 and/or the mixed stream 123 based on comparisons to data stored in the memory 402, such as desired ranges of the temperature and/or the flow of the stream 122 and/or the mixed stream 123, instructions stored in the memory 402, and/or data analyzed by the processor 404.

Furthermore, the controller 124 may adjust the temperature of the first adsorption module 104a based on inputted data stored by the control system 400, such as, but not limited to, the thickness and/or the chemical structure of the sorbent 116, and the resulting H₂O and/or CO₂ adsorption and desorption capacity of the adsorbent bed 112. The controller 124 may adjust the temperature and/or the flow of the stream 122 and/or the mixed stream 123 based on comparisons to data stored in the memory 402, such as H₂O adsorption and desorption capacities of one or more physical and/or chemical characteristics of sorbent 116, instructions stored in the memory 402, and/or measured data analyzed by the processor 404.

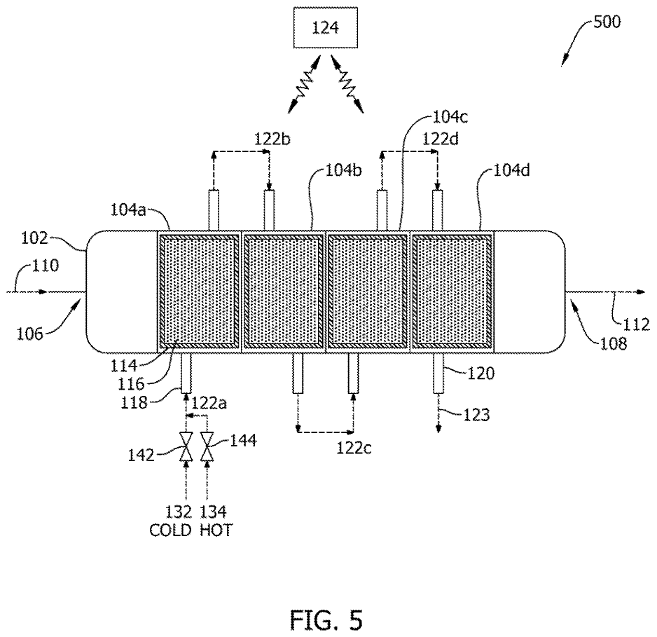

FIG. 5 is a schematic of a capture system 500 that may be used to capture CO₂ using the adsorbent bed 102. The capture system 500 illustrated in FIG. 5 is similar to the capture system 100 (shown in FIG. 1) and the capture system 300 (shown in FIG. 3), with the differences noted below, and as such, the same reference numbers for the same components are used in FIG. 5 as were used in FIGS. 1 and 3. In the exemplary embodiment, the first adsorption module 104a includes the contactor inlet 118 and the fourth adsorption module 104d includes the contactor outlet 120. The stream 122 received by the contactor inlet 118 facilitates modulating the temperature of at least one adsorption module 104a-d, with each adsorption module 104a-d being connected in a series flow relationship from the first adsorption module 104a to the fourth adsorption module 104d.

The controller 124 facilitates modulating the temperature of at least one adsorption module 104a-d by monitoring the temperature of the stream 122 as it proceeds through each adsorption module 104 a-d in series. For example, the line 502 may include one or more of the first valve sensor 127, the second valve sensor 129, and/or the third valve sensor 147 (shown in FIG. 4) to monitor the temperature of the stream 122a-d at each adsorption module 104a-d. In operating conditions where the control temperature T_{cntl} of at least one adsorption module 104 is higher than desired, the controller 124 may selectively decrease the temperature of the stream 122, thereby decreasing the temperature of the at least one adsorption module 104. Alternatively, in operating conditions where the control temperature T_{cntl} of at least one adsorption module 104 is higher than desired and the temperature of the stream 122 is lower than the control temperature T_{cntl} of the at least one adsorption module 104, the controller 124 may selectively increase the flow of the stream 122, thereby decreasing the temperature of the at least one adsorption module 104.

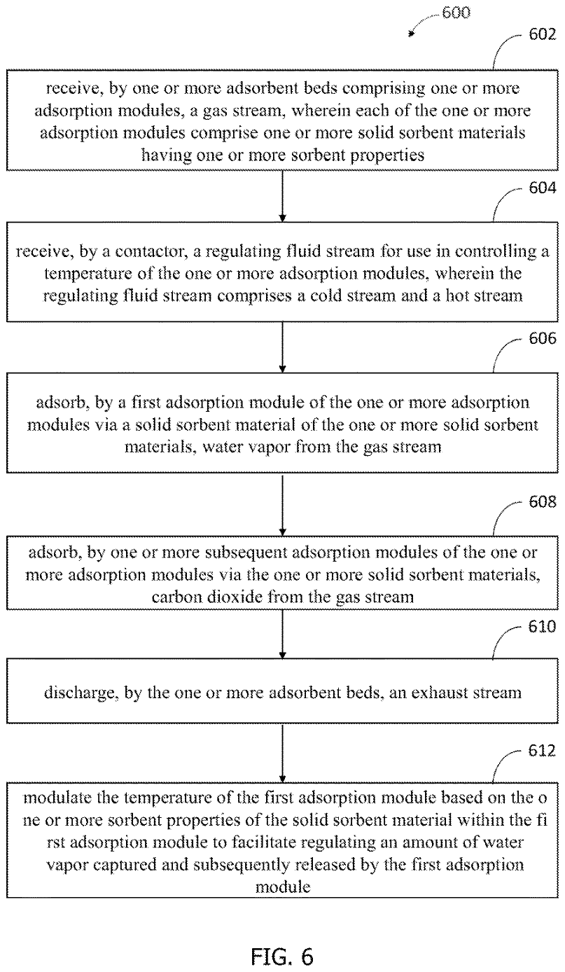

FIG. 6 is a flowchart illustrating an exemplary method 600 for capturing CO₂. In the exemplary embodiment, the method 600 includes receiving 602, by one or more adsorbent beds comprising one or more adsorption modules, a gas stream, wherein each of the one or more adsorption modules comprise one or more solid sorbent materials having one or more sorbent properties. The method 600 also includes receiving 604, by a contactor, a regulating fluid stream for use in controlling a temperature of the one or more adsorption modules, wherein the regulating fluid stream comprises a cold stream and a hot stream. The method 600 also includes adsorbing 606, by a first adsorption module of the one or more adsorption modules via a solid sorbent material of the one or more solid sorbent materials, water vapor from the gas stream, and adsorbing 608, by one or more subsequent adsorption modules of the one or more adsorption modules via the one or more solid sorbent materials, carbon dioxide from the gas stream. The method 600 further includes discharging 610, by the one or more adsorbent beds, an exhaust stream and modulating 612 the temperature of the first adsorption module based on the one or more sorbent properties of the solid sorbent material within the first adsorption module to facilitate regulating an amount of water vapor captured and subsequently released by the first adsorption module.

Exemplary systems and methods that use temperature management and physical and chemical characteristics of one or more solid sorbents to optimize the efficiency and productivity of water vapor adsorption and desorption by a first adsorption module of an adsorbent bed, thereby optimizing the adsorption and desorption of carbon dioxide gas by subsequent adsorption modules of the adsorbent bed, are described herein. The exemplary systems and methods as described herein provide several advantages over conventional designs and processes, including increasing the efficiency and performance of carbon dioxide adsorption and desorption within subsequent adsorption modules of the adsorbent bed by adsorbing and desorbing water vapor from the gas stream in the first adsorption module of the adsorbent bed, increasing the efficiency and performance of water vapor adsorption and desorption by varying chemical characteristics of one or more sorbents within a first adsorption module of an adsorbent bed, including, but not limited to, the chemical structure, and increasing the efficiency and performance of water vapor adsorption and desorption by varying physical characteristics of one or more sorbents within the first adsorption module of the adsorbent bed, including, but not limited to, the sorbent thickness.

The above description is meant to be exemplary only, and one skilled in the art will recognize that changes may be made to the embodiments described without departing from the scope of the invention disclosed. Modifications, which fall within the scope of the present invention, will be apparent to those skilled in the art, in light of a review of this disclosure, and such modifications are intended to fall within the appended claims. The systems described herein are not limited to the specific embodiments described herein, but rather portions of the various systems may be utilized independently and separately from other systems described herein.

Although specific features of various embodiments of the invention may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

Further aspects of the invention are provided by the subject matter of the following clauses:

A method for capturing carbon dioxide, the method comprising: receiving, by one or more adsorbent beds comprising one or more adsorption modules, a gas stream, wherein each of the one or more adsorption modules comprise one or more solid sorbent materials having one or more sorbent properties; receiving, by a contactor, a regulating fluid stream for use in controlling a temperature of the one or more adsorption modules, wherein the regulating fluid stream comprises a cold stream and a hot stream; adsorbing, by a first adsorption module of the one or more adsorption modules via a solid sorbent material of the one or more solid sorbent materials, water vapor from the gas stream; adsorbing, by one or more subsequent adsorption modules of the one or more adsorption modules via the one or more solid sorbent materials, carbon dioxide from the gas stream; discharging, by the one or more adsorbent beds, an exhaust stream; and modulating the temperature of the first adsorption module based on the one or more sorbent properties of the solid sorbent material within the first adsorption module to facilitate regulating an amount of water vapor captured and subsequently released by the first adsorption module.

The method in accordance with any of the preceding clauses, further comprising facilitating increasing an amount of carbon dioxide captured and subsequently released by the one or more subsequent adsorption modules.

The method in accordance with any of the preceding clauses, wherein varying one or more sorbent properties of the one or more solid sorbent materials comprises varying a sorbent thickness of the one or more solid sorbent materials.

The method in accordance with any of the preceding clauses, varying the one or more sorbent properties of the solid sorbent material comprises varying a sorbent chemical structure of the solid sorbent material within the first adsorption module.

The method in accordance with any of the preceding clauses, wherein varying the one or more sorbent properties of the solid sorbent material further comprises varying one or more of a porosity, a geometry, a size, and a shape of the solid sorbent material within the first adsorption module.

The method in accordance with any of the preceding clauses, further comprising modulating the temperature of the one or more subsequent adsorption modules to facilitate increasing the amount of carbon dioxide captured and subsequently released by the one or more adsorbent beds.

The method in accordance with any of the preceding clauses, wherein modulating the temperature of the one or more adsorption modules comprises: receiving the cold stream through a cold stream valve and receiving the hot stream through a hot stream valve; and modulating a flow of at least one of the cold stream through the cold stream valve and the hot stream through the hot stream valve.

The method in accordance with any of the preceding clauses, wherein modulating the temperature of the one or more adsorption modules further comprises modulating the flow of at least one of the cold stream and the hot stream to decrease a fluid temperature of the regulating fluid stream.

The method in accordance with any of the preceding clauses, wherein receiving a gas stream comprises receiving, by a plurality of adsorbent beds connected in parallel, the gas stream, each of the plurality of adsorbent beds comprising one or more adsorption modules.

The method in accordance with any of the preceding clauses, wherein receiving a gas stream comprises receiving, by one or more adsorbent beds, a gas stream, each of the one or more adsorbent beds comprising a plurality of adsorption modules connected in series.

A capture system for use in capturing carbon dioxide, the capture system comprising: one or more adsorbent beds comprising one or more adsorption modules, wherein the one or more adsorption modules comprise one or more solid sorbent materials having one or more sorbent properties, the one or more adsorbent beds oriented to: receive a gas stream; adsorb water vapor from the gas stream within a first adsorption module of the one or more adsorption modules via a solid sorbent material of the one or more solid sorbent materials; adsorb carbon dioxide from the gas stream within one or more subsequent adsorption modules of the one or more adsorption modules via the one or more solid sorbent materials; and discharge an exhaust stream depleted of water vapor and carbon dioxide; a contactor oriented to receive a regulating fluid stream for use in controlling a temperature of the one or more adsorption modules; and a controller configured to modulate the temperature of the first adsorption module based on the one or more sorbent properties of the solid sorbent material within the first adsorption module to facilitate regulating an amount of water vapor captured and subsequently released by the first adsorption module.

The capture system in accordance with any of the preceding clauses, wherein the controller is further configured to facilitate increasing an amount of carbon dioxide captured and subsequently released by the one or more subsequent adsorption modules.

The capture system in accordance with any of the preceding clauses, wherein the one or more sorbent properties of the solid sorbent material comprise a sorbent thickness of the solid sorbent material within the first adsorption module.

The capture system in accordance with any of the preceding clauses, wherein the one or more sorbent properties of the solid sorbent material comprise a sorbent chemical structure of the solid sorbent material within the first adsorption module.

The capture system in accordance with any of the preceding clauses, wherein varying the one or more sorbent properties of the solid sorbent material further comprises varying one or more of a porosity, a geometry, a size, and a shape of the solid sorbent material within the first adsorption module.

The capture system in accordance with any of the preceding clauses, wherein the controller is further configured to modulate the temperature of the one or more subsequent adsorption modules to facilitate increasing the amount of carbon dioxide captured and subsequently released by the one or more adsorbent beds.

The capture system in accordance with any of the preceding clauses, wherein the controller is further configured to: receive a cold stream through a cold stream valve and receive a hot stream through a hot stream valve; and modulate a flow of at least one of the cold stream through the cold stream valve and the hot stream through the hot stream valve.

The capture system in accordance with any of the preceding clauses, wherein the controller is further configured to modulate the flow of at least one of the cold stream and the hot stream to decrease a fluid temperature of the regulating fluid stream.

The capture system in accordance with any of the preceding clauses, wherein the one or more adsorbent beds comprises a plurality of adsorbent beds connected in parallel, each of the plurality of adsorbent beds comprising one or more adsorption modules.

The capture system in accordance with any of the preceding clauses, wherein the one or more adsorption modules comprises a plurality of adsorption modules connected in series.

While the invention has been described in terms of various specific embodiments, those skilled in the art will recognize that the invention can be practiced with modification within the spirit and scope of the claims.

What is claimed is:

1. A method for capturing carbon dioxide, the method comprising:
receiving, by one or more adsorbent beds comprising one or more adsorption modules, a gas stream, wherein each of the one or more adsorption modules comprise one or more solid sorbent materials having one or more sorbent properties;
receiving, by a contactor, a regulating fluid stream for use in controlling a temperature of the one or more adsorption modules, wherein the regulating fluid stream comprises a cold stream and a hot stream;
adsorbing, by a first adsorption module of the one or more adsorption modules via a solid sorbent material of the one or more solid sorbent materials, water vapor from the gas stream;
adsorbing, by one or more subsequent adsorption modules of the one or more adsorption modules via the one or more solid sorbent materials, carbon dioxide from the gas stream;
discharging, by the one or more adsorbent beds, an exhaust stream; and
modulating the temperature of the first adsorption module based on the one or more sorbent properties of the solid sorbent material within the first adsorption module to facilitate regulating an amount of water vapor captured and subsequently released by the first adsorption module.

2. The method in accordance with claim 1, further comprising facilitating increasing an amount of carbon dioxide captured and subsequently released by the one or more subsequent adsorption modules.

3. The method in accordance with claim 1, wherein varying one or more sorbent properties of the one or more solid sorbent materials comprises varying a sorbent thickness of the one or more solid sorbent materials.

4. The method in accordance with claim 1, wherein varying the one or more sorbent properties of the solid sorbent material comprises varying a sorbent chemical structure of the solid sorbent material within the first adsorption module.

5. The method in accordance with claim 4, wherein varying the one or more sorbent properties of the solid sorbent material further comprises varying one or more of a porosity, a geometry, a size, and a shape of the solid sorbent material within the first adsorption module.

6. The method in accordance with claim 2, further comprising modulating the temperature of the one or more subsequent adsorption modules to facilitate increasing the amount of carbon dioxide captured and subsequently released by the one or more adsorbent beds.

7. The method in accordance with claim 6, wherein modulating the temperature of the one or more adsorption modules comprises:
receiving the cold stream through a cold stream valve and receiving the hot stream through a hot stream valve; and
modulating a flow of at least one of the cold stream through the cold stream valve and the hot stream through the hot stream valve.

8. The method in accordance with claim 7, wherein modulating the temperature of the one or more adsorption modules further comprises modulating the flow of at least one of the cold stream and the hot stream to decrease a fluid temperature of the regulating fluid stream.

9. The method in accordance with claim 1, wherein receiving a gas stream comprises receiving, by a plurality of adsorbent beds connected in parallel, the gas stream, each of the plurality of adsorbent beds comprising one or more adsorption modules.

10. The method in accordance with claim 1, wherein receiving a gas stream comprises receiving, by one or more adsorbent beds, a gas stream, each of the one or more adsorbent beds comprising a plurality of adsorption modules connected in series.

11. A capture system for use in capturing carbon dioxide, the capture system comprising:
one or more adsorbent beds comprising one or more adsorption modules, wherein the one or more adsorption modules comprise one or more solid sorbent materials having one or more sorbent properties, the one or more adsorbent beds oriented to:
receive a gas stream;
adsorb water vapor from the gas stream within a first adsorption module of the one or more adsorption modules via a solid sorbent material of the one or more solid sorbent materials;
adsorb carbon dioxide from the gas stream within one or more subsequent adsorption modules of the one or more adsorption modules via the one or more solid sorbent materials; and
discharge an exhaust stream depleted of water vapor and carbon dioxide;
a contactor oriented to receive a regulating fluid stream for use in controlling a temperature of the one or more adsorption modules; and
a controller configured to modulate the temperature of the first adsorption module based on the one or more sorbent properties of the solid sorbent material within the first adsorption module to facilitate regulating an amount of water vapor captured and subsequently released by the first adsorption module.

12. The capture system in accordance with claim 11, wherein the controller is further configured to facilitate increasing an amount of carbon dioxide captured and subsequently released by the one or more subsequent adsorption modules.

13. The capture system in accordance with claim 11, wherein the one or more sorbent properties of the solid sorbent material comprise a sorbent thickness of the solid sorbent material within the first adsorption module.

14. The capture system in accordance with claim 11, wherein the one or more sorbent properties of the solid sorbent material comprise a sorbent chemical structure of the solid sorbent material within the first adsorption module.

15. The capture system in accordance with claim 14, wherein varying the one or more sorbent properties of the solid sorbent material further comprises varying one or more of a porosity, a geometry, a size, and a shape of the solid sorbent material within the first adsorption module.

16. The capture system in accordance with claim 12, wherein the controller is further configured to modulate the temperature of the one or more subsequent adsorption modules to facilitate increasing the amount of carbon dioxide captured and subsequently released by the one or more adsorbent beds.

17. The capture system in accordance with claim 16, wherein the controller is further configured to:
receive a cold stream through a cold stream valve and receive a hot stream through a hot stream valve; and
modulate a flow of at least one of the cold stream through the cold stream valve and the hot stream through the hot stream valve.

18. The capture system in accordance with claim 17, wherein the controller is further configured to modulate the flow of at least one of the cold stream and the hot stream to decrease a fluid temperature of the regulating fluid stream.

19. The capture system in accordance with claim 11, wherein the one or more adsorbent beds comprises a plurality of adsorbent beds connected in parallel, each of the plurality of adsorbent beds comprising one or more adsorption modules.

20. The capture system in accordance with claim 11, wherein the one or more adsorption modules comprises a plurality of adsorption modules connected in series.
